(19) United States
(12) Patent Application Publication
(10) Pub. No.: US 2024/0253386 A1
(43) Pub. Date: Aug. 1, 2024

(54) System and Method for Securing a Document with a Printed Geometric Security Background

(71) Applicant: DBP Communications, Inc., Bannockburn, IL (US)

(72) Inventor: Robert C. Kenehan, Lake Forest, IL (US)

(21) Appl. No.: 18/427,115

(22) Filed: Jan. 30, 2024

Related U.S. Application Data
(60) Provisional application No. 63/442,366, filed on Jan. 31, 2023.

(51) Int. Cl. B42D 25/378; B41M 3/14

(52) U.S. Cl. CPC B42D 25/378; B41M 3/14

(57) ABSTRACT

A security document comprises a document substrate and a pattern of repeated geometric shapes printed on the document substrate. The pattern of repeated geometric shapes comprises a first set of the geometric shapes printed using a reactive ink and a second set of the geometric shapes printed using a non-reactive ink. The geometric shapes fit closely together without substantial overlaps. In addition, a visual appearance of the reactive ink is substantially similar to a visual appearance of the non-reactive ink. The first set of geometric shapes or the second set of geometric shapes are arranged together to form one or more hidden symbols, pantographs or messages. A method of printing the security document is also disclosed.

### CROSS-REFERENCE TO RELATED APPLICATIONS

This application claims priority to U.S. Provisional Patent Application No. 63/442,366 filed on Jan. 31, 2023, and entitled “System and Method for Securing a Document with a Printed Geometric Security Background”. The foregoing patent application is hereby incorporated by reference in their entirety.

### TECHNICAL FIELD OF THE INVENTION

The present invention relates in general to documents and document printing, and more particularly, to a security document with a printed security background and a method of printing such security document.

### STATEMENT OF FEDERALLY FUNDED RESEARCH

None.

### BACKGROUND OF THE INVENTION

Without limiting the scope of the invention, its background is described in connection with security documents.

Many documents incorporate printed security patterns for authentication and to prevent counterfeiting and/or tampering.

Chemical tampering is a method used by fraudulent actors to “wash” or lift off certain printed information on a secure document while leaving the remaining print on the document unaffected. Once certain information is lifted off the document, new fraudulent information can be added. For example, laser imaging or pen ink can be chemically lifted from a secure document in a chemical bath allowing for fraud unless the original document has embedded features that will indicate evidence of chemical tampering.

Chemical tampering is often hard to detect. Current methods for detection of chemical tampering include printing with special solvent erasure laser (SEL) inks or using chemically treated security papers.

SEL inks are specifically formulated to react (dissolve) under exposure to solvents typically used for chemical washing. SEL inks when exposed to washing agents such as acetone, will release from the document by dissolving in the washing solution. However, when SEL inks are absent from a document, the absence of these inks may be a difficult indicator of chemical tampering, if the person authenticating is not aware of the absence of the indicator. SEL inks do not by themselves reveal a tamper evident message.

Current and similar tamper evident features readily used in secure document printing include using hidden printed VOID indicators to indicate evidence of photocopying or counterfeiting fraud from replication, and using hidden indicators incorporated within certain secure paper stocks appear as stains or messages with exposure to chemical washing. One methodology uses SEL and non-solvent reactive inks in a background pattern to create hidden messages. For example, the message can be printed in a pale non-solvent reactive ink, and then overprinted with a masking SEL ink in a pantograph pattern such that the message is revealed when the SEL mask is removed. In another example, the message is made of patterns within recognizable font shapes and is printed in the non-solvent reactive ink, and then the patterns are printed in the SEL ink adjacent to the message such that the message is revealed when the SEL mask is removed. However, registration variances inherent in high-speed print manufacturing can cause the messages to be visually detectable prior to washing.

Accordingly, there is a need for an effective means to deter chemical tampering by creating a security background that: (1) can be deployed across the background of a document; and (2) can be printed effectively on existing printing equipment without visual detection prior to chemical washing.

### SUMMARY OF THE INVENTION

Various embodiments of the present disclosure embed hidden symbols, pantographs or messages within a printed background of repeated geometric shapes revealed by the subtraction of a reactive ink from the printed background. The hidden symbols, pantographs or messages, rather than being made of a recognizable font shape, are rather made from the geometric shapes.

More specifically, one embodiment of the present disclosure provides a security document comprising a document substrate and a pattern of repeated geometric shapes printed on the document substrate. The pattern of repeated geometric shapes comprises a first set of the geometric shapes printed using a reactive ink and a second set of the geometric shapes printed using a non-reactive ink. The geometric shapes fit closely together without substantial overlaps. In addition, a visual appearance of the reactive ink is substantially similar to a visual appearance of the non-reactive ink. The first set of geometric shapes or the second set of geometric shapes are arranged to form one or more hidden symbols, pantographs or messages.

In one aspect, the reactive ink and the non-reactive ink are designed to print side-by-side using similar hues and differing solvent profiles. In another aspect, the reactive ink comprises a solvent erasure laser (SEL) ink, and the non-reactive ink comprises a standard ink. In another aspect, the pattern of repeated geometric shapes creates a substantially uniform background. In another aspect, the geometric shapes comprise circles, triangles, diamonds, trapezoids, rectangles, hexagons, squares, rhombus, polygons or any combination thereof. In another aspect, the pattern of repeated geometric shapes may further comprise a pattern of different colors, tints, tones or shades. In another aspect, a third set of geometric shapes or portions of geometric shapes within the pattern of repeated geometric shapes form one or more areas, symbols, pantographs or messages, and the first set of geometric shapes and the second set of geometric shapes are: (a) not printed in the one or more areas, symbols, pantographs or messages; or (b) printed in the one or more areas, symbols, pantographs or messages at a tint value that is higher than any of the tint values used for the first set and second set of geometric shapes printed outside the third set of geometric shapes. In another aspect, gaps or partial gaps are between the geometric shapes. In another aspect, the one or more hidden symbols, pantographs or messages remain undetectable when the first set of geometric shapes and the second set of geometric shapes are printed out of register. In another aspect, the reactive ink is substantially washed away by chemical tampering or washing, and the non-reactive ink is not substantially washed away by the chemical tampering or washing.

Another embodiment of the present disclosure provides a method for printing a security document. The method comprises providing a document substrate and selecting a pattern of repeated geometric shapes. The geometric shapes fit closely together without substantial overlaps. A first set of geometric shapes or a second set of geometric shapes is selected that together form one or more hidden symbols, pantographs or messages. The first set of geometric shapes are printed on the document substrate using a reactive ink, and the second set of geometric shapes are printed on the document substrate using a non-reactive ink. A visual appearance of the reactive ink is substantially similar to a visual appearance of the non-reactive ink.

In one aspect, the reactive ink and the non-reactive ink are designed to print side-by-side using similar hues and differing solvent profiles. In another aspect, the reactive ink comprises a solvent erasure laser (SEL) ink, and the non-reactive ink comprises a standard ink. In another aspect, the pattern of repeated geometric shapes creates a substantially uniform background. In another aspect, the geometric shapes comprise circles, triangles, diamonds, trapezoids, rectangles, hexagons, squares, rhombus, polygons or any combination thereof. In another aspect, the pattern of repeated geometric shapes may further comprise a pattern of different colors, tints, tones or shades. In another aspect, the method further comprises selecting a third set of geometric shapes or portions of geometric shapes within the pattern of repeated geometric shapes that together form one or more areas, symbols, pantographs or messages, and wherein the first set of geometric shapes and the second set of geometric shapes are: (a) not printed in the one or more areas, symbols, pantographs or messages; or (b) printed in the one or more areas, symbols, pantographs or messages at a tint value that is higher than any of the tint values used for the first set and second set of geometric shapes printed outside the third set of geometric shapes. In another aspect, gaps or partial gaps are between the geometric shapes. In another aspect, the one or more hidden symbols, pantographs or messages remain undetectable when the first set of geometric shapes and the second set of geometric shapes are printed out of register. In another aspect, the reactive ink is substantially washed away by chemical tampering or washing, and the non-reactive ink is not substantially washed away by the chemical tampering or washing.

Note that the invention is not limited to the embodiments described herein, instead it has the applicability beyond the embodiments described herein. The brief and detailed descriptions of this disclosure are given in the following.

### BRIEF DESCRIPTION OF THE DRAWINGS

For a more complete understanding of the features and advantages of the present invention, reference is now made to the detailed description of the invention along with the accompanying figures and in which:

FIG. 1 is an example of a background made up of small geometric shapes, namely diamonds, printed in a repeating pattern on a substrate in accordance with one embodiment of the present disclosure;

FIG. 2A is a security document in accordance with one embodiment of the present disclosure;

FIGS. 2B and 2C show color separated patterns that when printed together with SEL and standard inks in the same hue form the uniform background pattern of FIG. 2A;

FIGS. 3A and 3B depict an example in which the void pattern rotated by 30 degrees to create a diagonal VOID pattern in accordance with one embodiment of the present disclosure;

FIG. 4 shows the effect of chemical washing on a printed security document in accordance with one embodiment of the present disclosure;

FIG. 5 shows the effect of chemical washing on a printed security document in accordance with another embodiment of the present disclosure;

FIG. 6A depicts a portion of repeated geometric shapes in which the first set of geometric shapes and the second set of geometric shapes are printed substantially in register in accordance with one embodiment of the present disclosure;

FIG. 6B depicts a portion of the repeated geometric shapes in which some of the first set of geometric shapes and the second set of geometric shapes are printed out of register such that the hidden message is not readily discernable in accordance with another embodiment of the present disclosure;

FIGS. 7A and 7B show the background diamond shapes printed in a repeating pattern of 20% tint and 25% tint embellishment in accordance with one embodiment of the present disclosure;

FIGS. 8A and 8B show the background diamond shapes printed in a repeating pattern of 20% tint and 25% tint embellishment in accordance with another embodiment of the present disclosure;

FIGS. 9A, 9B and 9C show the background of hexagon tile shapes are printed in a repeating pattern of 20% tint and 30% tint with a zig zag embellishment in accordance with another embodiment of the present disclosure;

FIGS. 10A and 10B show the background of hexagon tile shapes are printed in a repeating pattern of 20% tint and 30% tint with a zig zag embellishment in accordance with another embodiment of the present disclosure;

FIGS. 11A and 11B show a hidden void geometric pattern is revealed with additional design embellishment of a step and repeat logo reverse pantograph in white in accordance with another embodiment of the present disclosure; and

FIG. 12 is a flow chart of a method for printing a security document in accordance with one embodiment of the present disclosure.

### DETAILED DESCRIPTION OF THE INVENTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

To facilitate the understanding of this invention, a number of terms are defined below. Terms defined herein have meanings as commonly understood by a person of ordinary skill in the areas relevant to the present invention. Terms such as “a”, “an” and “the” are not intended to refer to only a singular entity but include the general class of which a specific example may be used for illustration. The terminology herein is used to describe specific embodiments of the invention, but their usage does not limit the invention, except as outlined in the claims.

Various methods are described below to provide an example of each claimed embodiment. They do not limit any claimed embodiment. Any claimed embodiment may cover methods that are different from those described above and below. The drawings and descriptions are for illustrative, rather than restrictive, purposes.

Various embodiments of the present disclosure embed hidden symbols, pantographs or messages within a printed background of repeated geometric shapes revealed by the subtraction of a reactive ink from the printed background. The hidden symbols, pantographs or messages, rather than being made of a recognizable shape, such as a font, are rather made from the combination of geometric shapes that can be visibly understood as a symbol, pantograph or letter. There is no discernable font used for the hidden message as words are formed by an arrangement of tiles—forming a rough letter shape although recognizable to the average person. The tamper evident design pattern can be customized and incorporated into the entire face of the document as the main background design. Note that in some cases, it may be desirable to have separate authentication sections or different authentication sections in the security document.

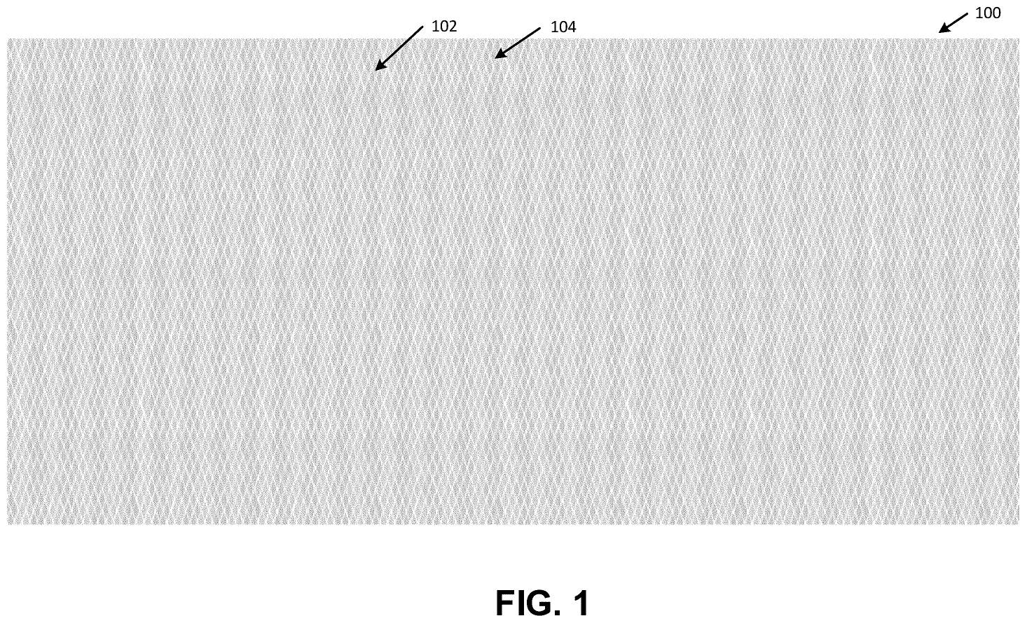

Now referring to FIG. 1, an example of a background 100 made up of small geometric shapes 102, namely diamonds, printed in a repeating pattern on a substrate 104 in accordance with one embodiment of the present disclosure is shown. Each geometric shape 102 or tile can be assigned a specific color. The backgrounds are made of small tiles or pixels of a predetermined shape and pattern. The predetermined shape, such circles, triangles, diamonds, trapezoids, rectangles, hexagons, squares, rhombus, polygons or any combination thereof, is somewhat irrelevant as any shape is effective as long as it can be interlocked to create a background of many small tiles. During the design process, tiles or pixels are assigned a geometric shape and given a screen density and then placed close to one another in a repeating pattern so that the layman sees the tile pattern as a substantially uniform background. The backgrounds can be easily customized to satisfy the customer's needs and desires. Moreover, the background can be tinted to any desired density or varying densities without affecting functionality.

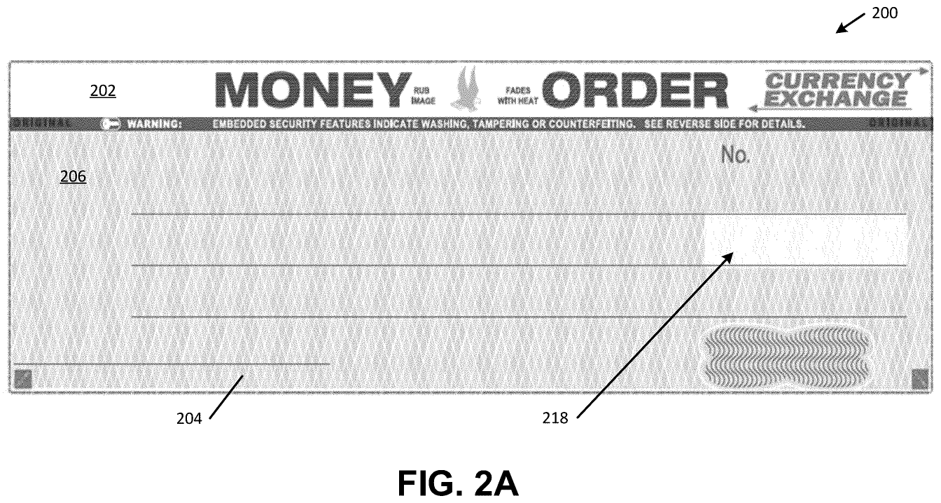

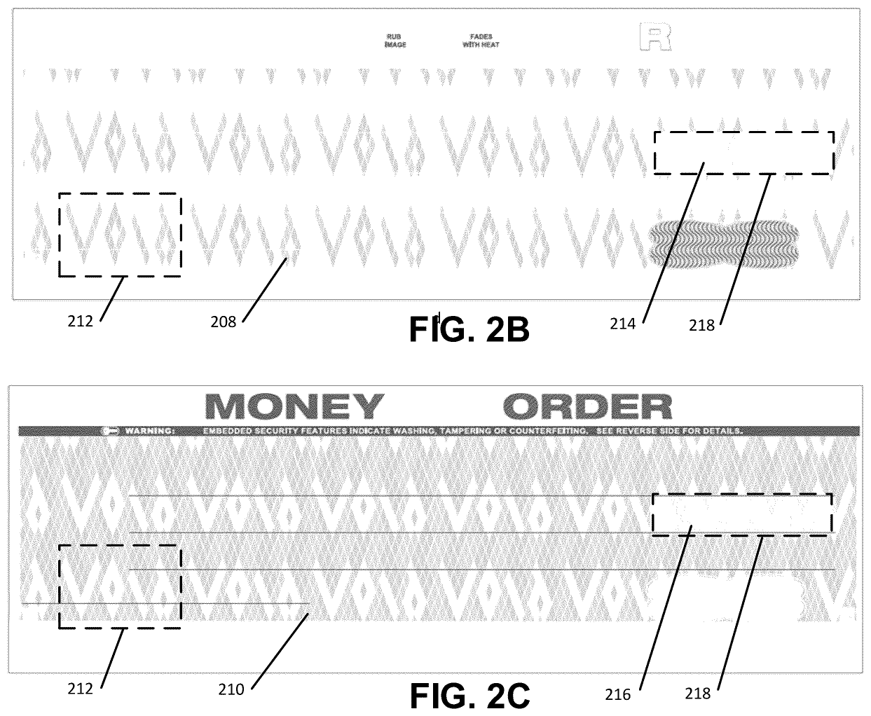

Referring now to FIG. 2A, a security document 200 in accordance with one embodiment of the present disclosure is shown. The security document 200 includes a document substrate 202 and a pattern of repeated geometric shapes or tiles 204 printed on the document substrate 202. In this non-limiting example, the geometric shapes or tiles 204 are diamond shapes that are tinted and placed tightly together to create a substantially uniform background 206. The pattern of repeated geometric shapes or tiles 204 includes a first set of the geometric shapes 208 printed using a non-reactive ink as shown in FIG. 2B, and a second set of the geometric shapes 210 printed using a reactive ink as shown in FIG. 2C. The reactive ink is designed to substantially dissolve off the document 200 under chemical tampering or washing. In contrast, the non-reactive ink is designed to substantially remain on the document 200 under chemical tampering or washing. The geometric shapes 208 and 210 fit closely together without substantial overlaps. Moreover, a visual appearance of the non-reactive ink (FIG. 2B) is substantially similar to a visual appearance of the reactive ink (FIG. 2C). In this case, the first set of geometric shapes 208 are arranged together to form one or more hidden symbols, pantographs or messages 212, such as “VOID”, as shown in FIGS. 2B and 2C. The tamper evident message is comprised by arranging the background shapes or tiles together in a pattern and not a font. Only complete shapes or tiles are used to form the hidden symbols, pantographs or messages because partial shapes or tiles can result in visual detection when using existing printing equipment. Note that the inks can be reversed such that the second set of geometric shapes 210 are printed using the non-reactive ink and the first set of geometric shapes 208 are printed using the reactive ink. Various combinations could also be used. In either case, the reactive ink and the non-reactive ink are designed to print side-by-side using similar hues and differing solvent profiles. For example, the reactive ink can be a solvent erasure laser (SEL) ink, and the non-reactive ink can be a conventional or standard ink.

The background tile pattern is not limited to a specific geometric shape or arrangement as long as shapes can be formed into a grid from which certain tiles can be assigned as solvent sensitive and the grid contains a sufficient quantity of tiles that together form hidden symbols, pantographs or messages. For example, the geometric shapes 208 and 210 can be circles, triangles, diamonds, trapezoids, rectangles, hexagons, squares, rhombus, polygons or any combination thereof. The hidden symbols, pantographs or messages 212 can repeat themselves as shown in FIGS. 2B and 2C, or there can be multiple different hidden symbols, pantographs or messages. In some embodiments, the grid is tessellated. In other embodiments, gaps or partial gaps exist between the geometric shapes. Each individual tile will be predetermined to print in a specific color, and the tiles will be registered together to create a substantially uniform background.

In some embodiments, the pattern of repeated geometric shapes or tiles 204 includes a third set of geometric shapes or portions of geometric shapes 214 (FIG. 2B), 216 (FIG. 2C) that together form one or more areas, symbols, pantographs or messages 218. In this example, the third set of geometric shapes 214 (FIG. 2B), 216 (FIG. 2C) together form a rectangular area 218 having a lighter color than the rest of the background 206. More specifically, the first set of geometric shapes 208 (FIG. 2B) and the second set of geometric shapes 210 (FIG. 2C) are printed in the one or more areas, symbols, pantographs or messages 218 at a tint value that is higher than any of the tint values used for first set of geometric shapes 208 (FIG. 2B) and the second set of geometric shapes 210 (FIG. 2C).

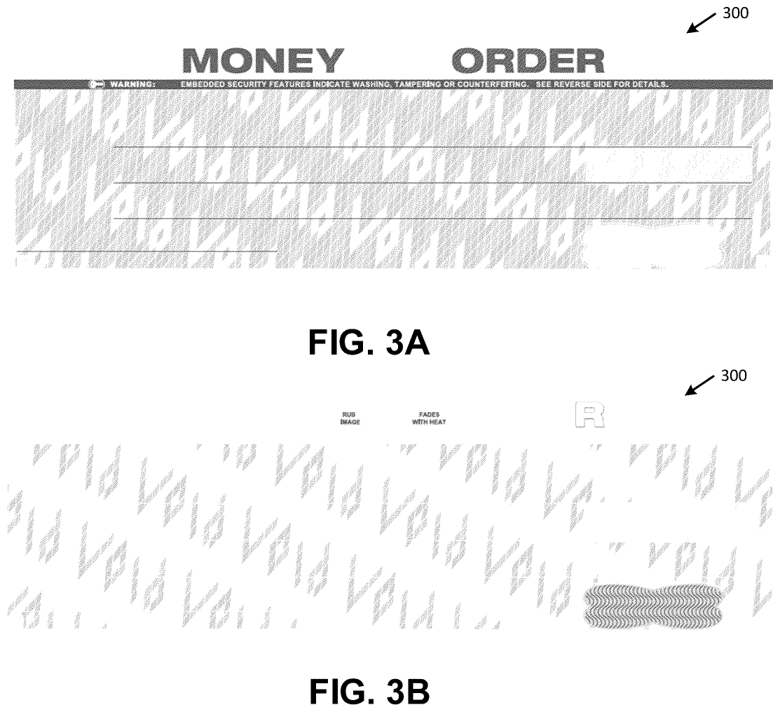

The design can be manipulated to change the angle or location of the one or more hidden symbols, pantographs or messages. For example, the “VOID” pattern on the security document 300 can be rotated by 30 degrees to create a diagonal “VOID” pattern as shown in FIGS. 3A and 3B. Other angles can be used. The tile shape or hue or tint can also be easily changed based on desired background design. Also, the pattern can be enlarged or reduced without altering the effectiveness of invention.

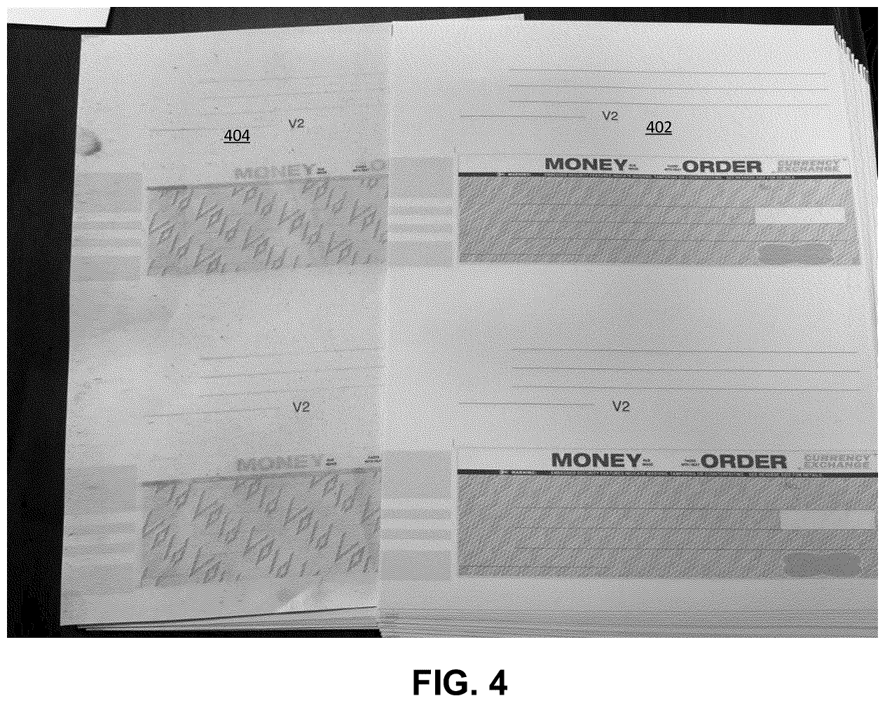

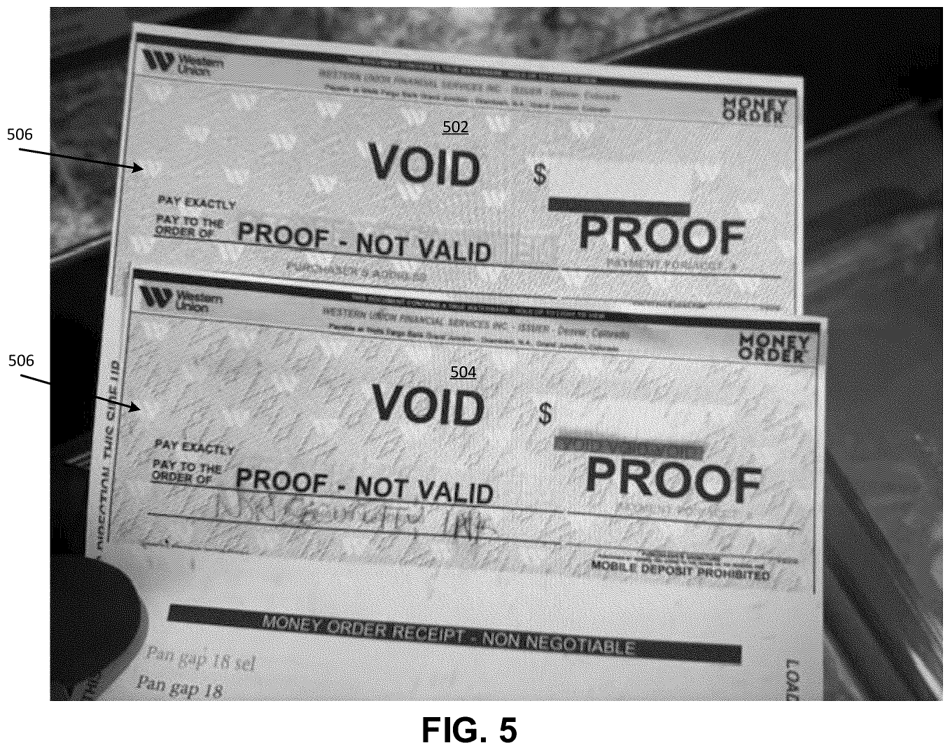

Now referring to FIG. 4, the effect of chemical washing on a printed security document in accordance with one embodiment of the present disclosure is shown. The original unwashed security document 402 is shown on the right with a substantially uniform background. In contrast, security document 404 is identical to 402 in all respects, other than exposure to chemical washing. After the solvent reactive ink is washed away, repeating “VOID” messages are clearly revealed. Similarly, FIG. 5 shows another example in which the original unwashed security document 502 is at the top with a substantially uniform background. In contrast, the chemically washed security document 504 is shown at the bottom where the “VOID” messages are clearly revealed. In this embodiment, the pattern of repeated geometric shapes or tiles includes a third set of geometric shapes or portions of geometric shapes that together form one or more areas, symbols, pantographs or messages 506, which in this case is the Western Union logo. In this example, the first set of geometric shapes and the second set of geometric shapes are not printed in the one or more areas, symbols, pantographs or messages 506. In both examples, the reactive ink was substantially washed away by chemical tampering or washing, and the non-reactive ink was not substantially washed away by chemical tampering or washing. Note that the exclusion of embellishment within the background, by eliminating the use of a varied tint pattern does not enhance or dimmish effectiveness of the invention. Security document 502 represents that a pattern of shapes printed with a uniform density will conceal the hidden message feature equally to an “embellished” background.

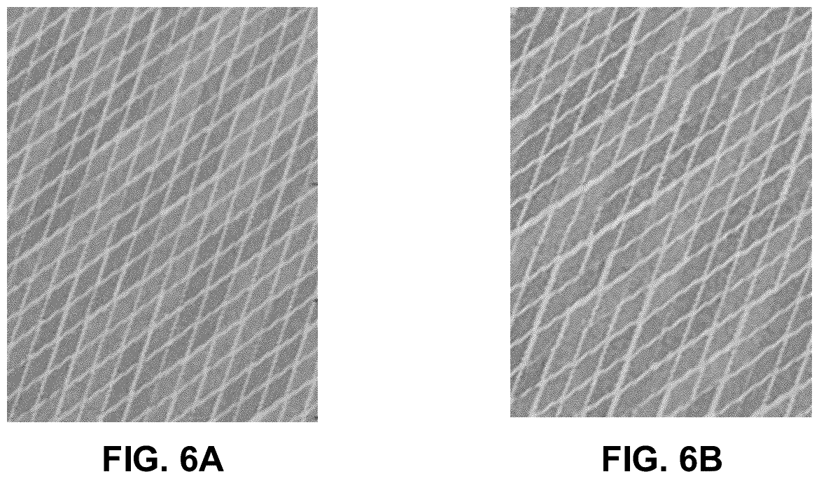

The hidden symbols, pantographs or messages designed from a series of geometric tiles will remain undetectable even if color plates are printed out of register. For example, FIG. 6A depicts a portion of repeated geometric shapes in which the first set of geometric shapes and the second set of geometric shapes are printed substantially in register. In contrast, FIG. 6B depicts a portion of the repeated geometric shapes in which some of the first set of geometric shapes and the second set of geometric shapes are printed out of register. FIG. 6B demonstrates that creating hidden messaging from tiles within a geometric background is more covert than hidden messages made from human readable fonts because it effectively minimizing registration issues on press without risk of revealing a hidden message within the secure document.

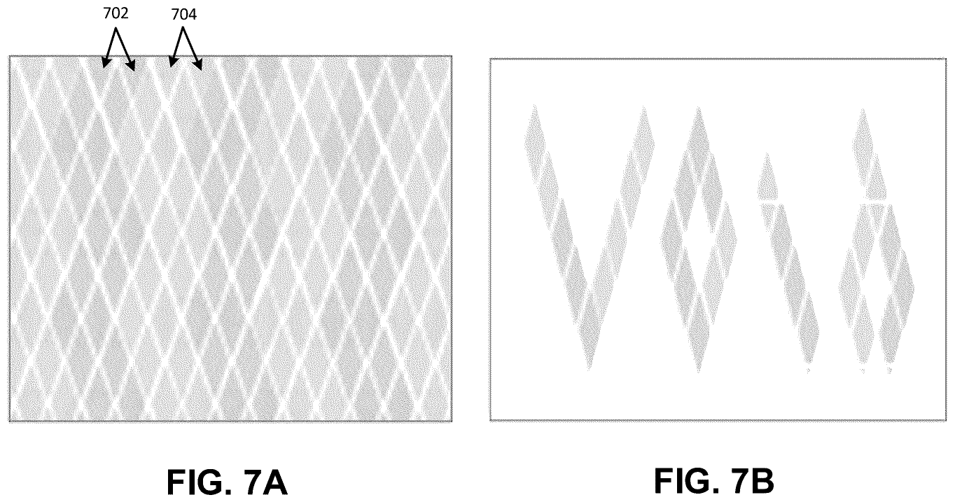

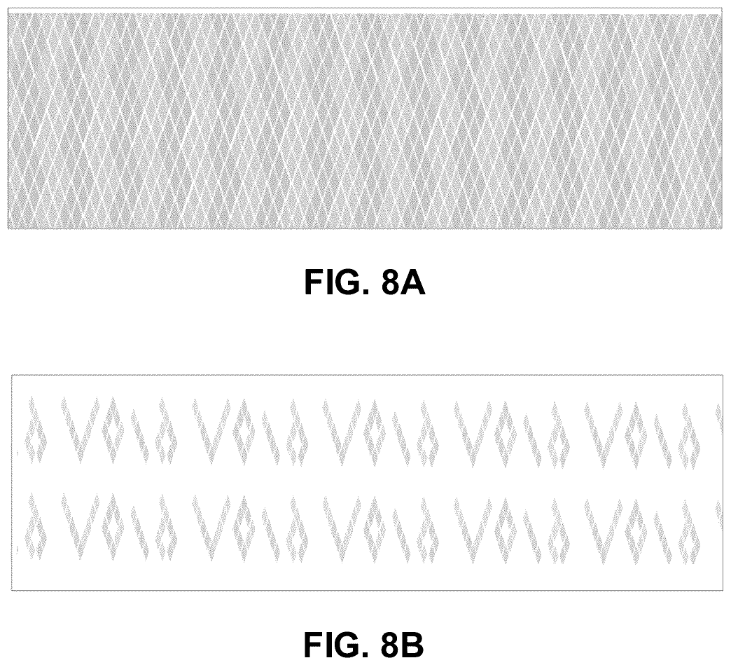

Referring now to FIG. 7A, the background diamond shapes are printed in a repeating pattern of 20% tint 702 and 25% tint 704 embellishment in accordance with one embodiment of the present disclosure. The background is comprised of both solvent sensitive ink and standard ink printing in same PMS color. Using varying tint values can create light and dark variations in both colors without affecting functionality. As shown in FIG. 7B, the message is revealed as solvent sensitive ink is removed from chemical washing showing only tiles printed in Standard Ink at 20% and 25% tint value. Similarly, a diamond grid pattern is repeated to create larger security background in FIG. 8A, and the pattern is revealed after solvent sensitive ink is removed in FIG. 8B.

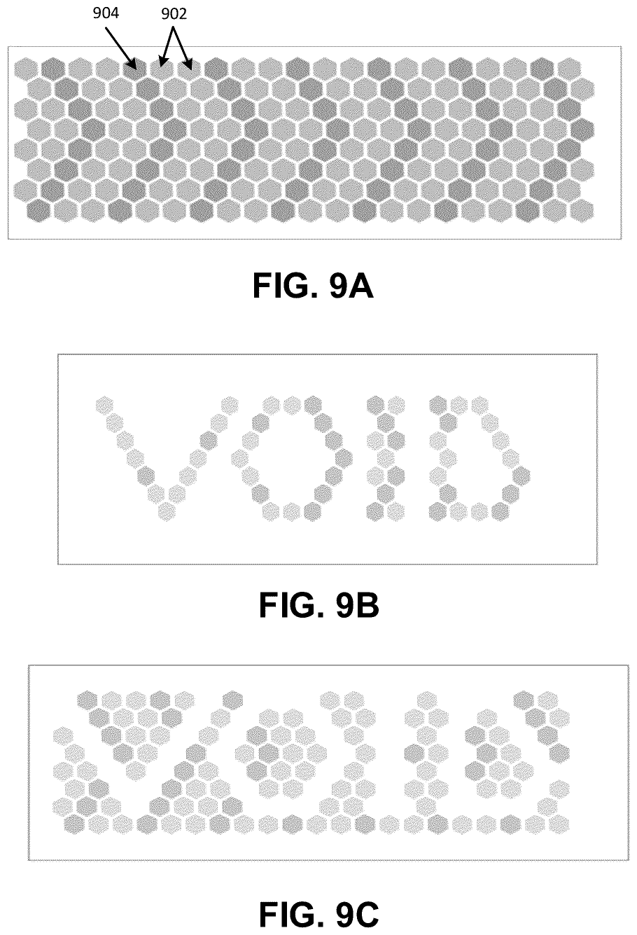

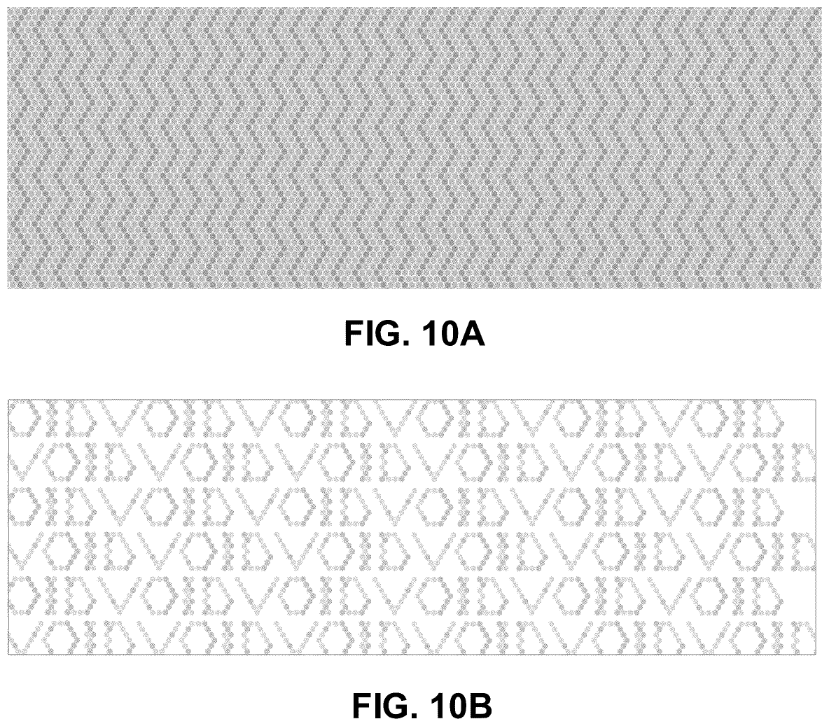

Now referring to FIG. 9A, a background of hexagon tile shapes is printed in a repeating pattern of 20% tint 902 and 30% tint 904 with a zig zag embellishment in accordance with another embodiment of the present disclosure. The combined background pattern has both inks with the same hue and tinting at 20% and 30% in both colors. FIG. 9B shows the standard ink is revealed after solvent sensitive ink tiles are removed via chemical washing. FIG. 9C shows the solvent sensitive ink tiles are isolated. Similarly, the pattern can be repeated to create a larger security background as shown in FIG. 10A, and the pattern is revealed after solvent sensitive ink is removed in FIG. 10B.

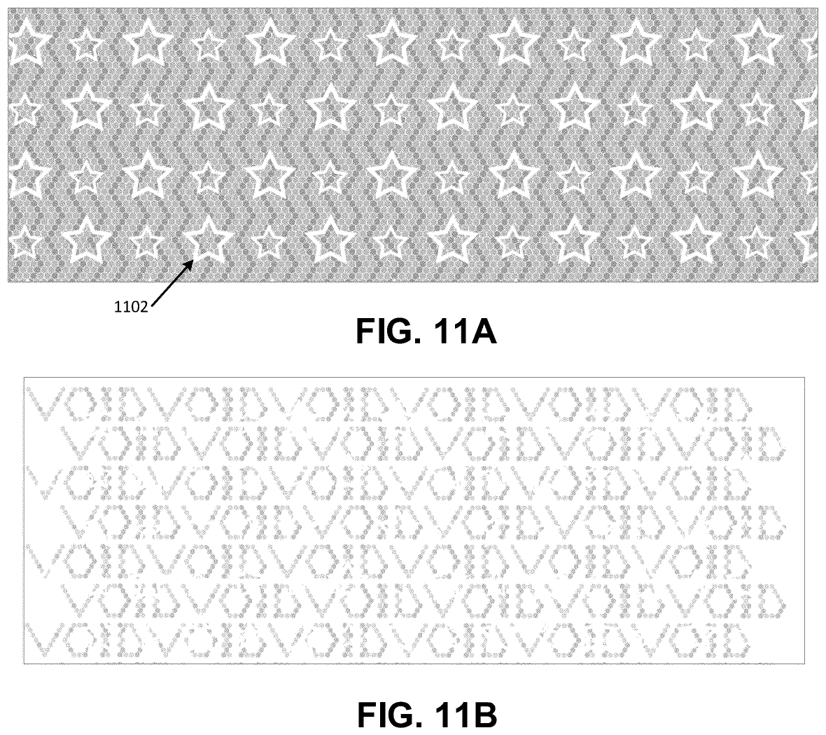

Referring now to FIG. 11A, a hidden void geometric pattern is revealed with additional design embellishment of a step and repeat logo reverse pantograph 1102 in white in accordance with another embodiment of the present disclosure. A pattern is revealed after solvent sensitive ink is removed in FIG. 11B. Step and repeat reverse patterns can be embedded within the design with minimal loss of embedded security.

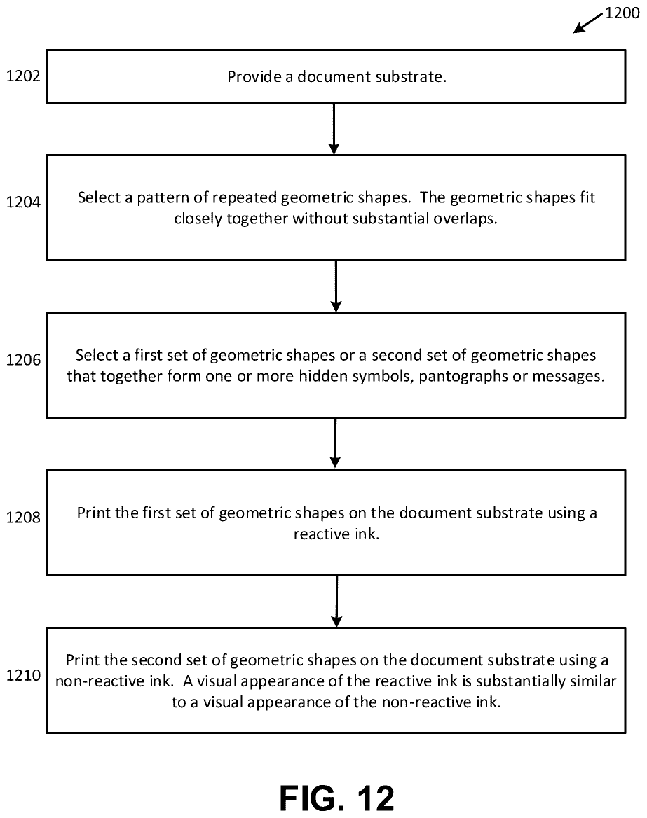

Now referring to FIG. 12, a method 1200 for printing a security document in accordance with one embodiment of the present disclosure is shown. A document substrate is provided in block 1202 and a pattern of repeated geometric shapes is selected in block 1204. The geometric shapes fit closely together without substantial overlaps. A first set of geometric shapes or a second set of geometric shapes is selected that together form one or more hidden symbols, pantographs or messages in block 1206. The first set of geometric shapes are printed on the document substrate using a reactive ink in block 1208, and the second set of geometric shapes are printed on the document substrate using a non-reactive ink in block 1210. A visual appearance of the reactive ink is substantially similar to a visual appearance of the non-reactive ink.

In one aspect, the reactive ink and the non-reactive ink are designed to print side-by-side using similar hues and differing solvent profiles. In another aspect, the reactive ink comprises a solvent erasure laser (SEL) ink, and the non-reactive ink comprises a standard ink. In another aspect, the pattern of repeated geometric shapes creates a substantially uniform background. In another aspect, the geometric shapes comprise circles, triangles, diamonds, trapezoids, rectangles, hexagons, squares, rhombus, polygons or any combination thereof. In another aspect, the pattern of repeated geometric shapes may further comprise a pattern of different colors, tints, tones or shades. In another aspect, the method further comprises selecting a third set of geometric shapes or portions of geometric shapes within the pattern of repeated geometric shapes that together form one or more areas, symbols, pantographs or messages, and wherein the first set of geometric shapes and the second set of geometric shapes are: (a) not printed in the one or more areas, symbols, pantographs or messages; or (b) printed in the one or more areas, symbols, pantographs or messages at a tint value that is higher than any of the tint values used for the first set and second set of geometric shapes printed outside the third set of geometric shapes. In another aspect, gaps or partial gaps are between the geometric shapes. In another aspect, the one or more hidden symbols, pantographs or messages remain undetectable when the first set of geometric shapes and the second set of geometric shapes are printed out of register. In another aspect, the reactive ink is substantially washed away by chemical tampering or washing, and the non-reactive ink is not substantially washed away by the chemical tampering or washing.

It is understood that particular embodiments described herein are shown by way of illustration and not as limitations of the invention. The principal features of this invention can be employed in various embodiments without departing from the scope of the invention. Those skilled in the art will recognize or be able to ascertain using no more than routine experimentation, numerous equivalents to the specific procedures described herein. Such equivalents are considered to be within the scope of this invention and are covered by the claims.

All publications and patent applications mentioned in the specification are indicative of the level of skill of those skilled in the art to which this invention pertains. All publications and patent applications are herein incorporated by reference to the same extent as if each individual publication or patent application was specifically and individually indicated to be incorporated by reference.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited features, elements, components, groups, integers, and/or steps, but do not exclude the presence of other unstated features, elements, components, groups, integers and/or steps. In embodiments of any of the compositions and methods provided herein, “comprising” may be replaced with “consisting essentially of” or “consisting of”. As used herein, the term “consisting” is used to indicate the presence of the recited integer (e.g., a feature, an element, a characteristic, a property, a method/process step or a limitation) or group of integers (e.g., feature(s), element(s), characteristic(s), property(ies), method/process steps or limitation(s)) only. As used herein, the phrase “consisting essentially of” requires the specified features, elements, components, groups, integers, and/or steps, but do not exclude the presence of other unstated features, elements, components, groups, integers and/or steps as well as those that do not materially affect the basic and novel characteristic(s) and/or function of the claimed invention.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

As used herein, words of approximation such as, without limitation, “about”, “substantial” or “substantially” refers to a condition that when so modified is understood to not necessarily be absolute or perfect but would be considered close enough to those of ordinary skill in the art to warrant designating the condition as being present. The extent to which the description may vary will depend on how great a change can be instituted and still have one of ordinary skill in the art recognize the modified feature as still having the required characteristics and capabilities of the unmodified feature. In general, but subject to the preceding discussion, a numerical value herein that is modified by a word of approximation such as “about” may vary from the stated value by at least ±1, 2, 3, 4, 5, 6, 7, 10, 12 or 15%.

All of the compositions and/or methods disclosed and claimed herein can be made and executed without undue experimentation in light of the present disclosure. While the compositions and methods of this invention have been described in terms of preferred embodiments, it will be apparent to those of skill in the art that variations may be applied to the compositions and/or methods and in the steps or in the sequence of steps of the method described herein without departing from the concept, spirit and scope of the invention. All such similar substitutes and modifications apparent to those skilled in the art are deemed to be within the spirit, scope and concept of the invention as defined by the appended claims.

To aid the Patent Office, and any readers of any patent issued on this application in interpreting the claims appended hereto, applicants wish to note that they do not intend any of the appended claims to invoke paragraph 6 of 35 U.S.C. § 112, U.S.C. § 112 paragraph (f), or equivalent, as it exists on the date of filing hereof unless the words “means for” or “step for” are explicitly used in the particular claim.

For each of the claims, each dependent claim can depend both from the independent claim and from each of the prior dependent claims for each and every claim so long as the prior claim provides a proper antecedent basis for a claim term or element.

What is claimed is:

1. A security document comprising:
a document substrate;
a pattern of repeated geometric shapes printed on the document substrate comprising a first set of the geometric shapes printed using a reactive ink and a second set of the geometric shapes printed using a non-reactive ink, wherein the geometric shapes fit closely together without substantial overlaps and a visual appearance of the reactive ink is substantially similar to a visual appearance of the non-reactive ink; and
the first set of geometric shapes or the second set of geometric shapes are arranged together to form one or more hidden symbols, pantographs or messages.

2. The security document of claim 1, wherein the reactive ink and the non-reactive ink are designed to print side-by-side using similar hues and differing solvent profiles.

3. The security document of claim 1, wherein:
the reactive ink comprises a solvent erasure laser (SEL) ink; and
the non-reactive ink comprises a standard ink.

4. The security document of claim 1, wherein the pattern of repeated geometric shapes creates a substantially uniform background.

5. The security document of claim 1, wherein the geometric shapes comprise circles, triangles, diamonds, trapezoids, rectangles, hexagons, squares, rhombus, polygons or any combination thereof.

6. The security document of claim 1, wherein the pattern of repeated geometric shapes further comprises a pattern of different colors, tints, tones or shades.

7. The security document of claim 1, further comprising:
a third set of geometric shapes or portions of geometric shapes within the pattern of repeated geometric shapes that together form one or more areas, symbols, pantographs or messages; and
wherein the first set of geometric shapes and the second set of geometric shapes are: (a) not printed in the one or more areas, symbols, pantographs or messages; or (b) printed in the one or more areas, symbols, pantographs or messages at a tint value that is higher than any of the tint values used for the first set and second set of geometric shapes printed outside the third set of geometric shapes.

8. The security document of claim 1, further comprising gaps or partial gaps between the geometric shapes.

9. The security document of claim 1, wherein the one or more hidden symbols, pantographs or messages remain undetectable when the first set of geometric shapes and the second set of geometric shapes are printed out of register.

10. The security document of claim 1, wherein:
the reactive ink is substantially washed away by a chemical tampering or washing; and
the non-reactive ink is not substantially washed away by the chemical tampering or washing.

11. A method for printing a security document, the method comprising:
providing a document substrate;
selecting a pattern of repeated geometric shapes, wherein the geometric shapes fit closely together without substantial overlaps;
selecting a first set of geometric shapes or a second set of geometric shapes that together form one or more hidden symbols, pantographs or messages;
printing the first set of geometric shapes on the document substrate using a reactive ink; and
printing the second set of geometric shapes on the document substrate using a non-reactive ink, wherein a visual appearance of the reactive ink is substantially similar to a visual appearance of the non-reactive ink.

12. The method of claim 11, wherein the reactive ink and the non-reactive ink are designed to print side-by-side using similar hues and differing solvent profiles.

13. The method of claim 11, wherein:
the reactive ink comprises a solvent erasure laser (SEL) ink; and
the non-reactive ink comprises a standard ink.

14. The method of claim 11, wherein the pattern of repeated geometric shapes creates a uniform background.

15. The method of claim 11, wherein the geometric shapes comprise circles, triangles, diamonds, trapezoids, rectangles, hexagons, squares, rhombus, polygons or any combination thereof.

16. The method of claim 11, wherein the pattern of repeated geometric shapes further comprises a pattern of different colors, tints, tones or shades.

17. The method of claim 11, further comprising:
selecting a third set of geometric shapes or portions of geometric shapes within the pattern of repeated geometric shapes that together form one or more areas, symbols, pantographs or messages; and
wherein the first set of geometric shapes and the second set of geometric shapes are: (a) not printed in the one or more areas, symbols, pantographs or messages; or (b) printed in the one or more areas, symbols, pantographs or messages at a tint value that is higher than any of the tint values used for the first set and second set of geometric shapes printed outside the third set of geometric shapes.

18. The method of claim 11, further comprising gaps or partial gaps between the geometric shapes.

19. The method of claim 11, wherein the one or more hidden symbols, pantographs or messages remain undetectable when the first set of geometric shapes and the second set of geometric shapes are printed out of register.

20. The method of claim 11, wherein:
the reactive ink is substantially washed away by a chemical tampering or washing; and
the non-reactive ink is not substantially washed away by the chemical tampering or washing.
